(19) United States
(12) Patent Application Publication
(10) Pub. No.: US 2008/0114531 A1
(43) Pub. Date: May 15, 2008

(54) Communication apparatus for use in intervehicle communication system and program for same

(75) Inventor: Masakazu Kagawa, Inuyama-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/983,015

(22) Filed: Nov. 6, 2007

(30) Foreign Application Priority Data
Nov. 14, 2006 (JP) 2006-308260

(51) Int. Cl. G06F 19/00

(52) U.S. Cl. 701/119; 701/117

(57) ABSTRACT

A communication apparatus on a subject vehicle detects surrounding vehicles based on a detection result of a radar or the like for generating a subject device vehicle data list. Then, similar lists are acquired from other apparatuses for deleting co-existing vehicles from the subject device vehicle data list. Co-existing vehicles are also deleted from the subject device vehicle data list by receiving the similar lists from roadside devices. Then, the subject device vehicle data list is transmitted to other vehicles. In this manner, the total amount of communication data exchanged between apparatuses is reduced due to a reduction of duplicated vehicle information.

### CROSS REFERENCE TO RELATED APPLICATION

This application is based on and claims the benefit of priority of Japanese Patent Application No. 2006-308260 filed on Nov. 14, 2006, the disclosure of which is incorporated herein by reference.

### FIELD OF THE DISCLOSURE

The present disclosure generally relates to a vehicle to vehicle communication apparatus for use in a vehicle.

### BACKGROUND INFORMATION

In recent years, vehicle to vehicle communication by communication devices on other vehicles is known for detecting and to presenting other vehicle position or the like for a driver of the vehicle. For example, Japanese patent document JP-A-2005-301581 (also published as US patent document No. 20050225457) discloses a technique that transmits not only the position information of an equipped vehicle that has the communication device but also the position information of surrounding vehicles that are captured by a camera or the like on the equipped vehicle. In this case, the surrounding vehicles includes the equipped vehicles and “not-equipped” vehicles that are not equipped with the communication device. Therefore, existence of the not-equipped vehicles that can not be seen at a position of one equipped vehicle is recognized based on information derived from the communication device on another equipped vehicle at a proximity of the one equipped vehicle. That is, driver's recognition area is extended to a wider coverage for an improved safety.

However, when many of the vehicles are equipped with the communication device, one not-equipped vehicle may be detected by plural equipped vehicles and information on the not-equipped vehicle is included in many instances of the transmitted information in a duplicate manner. As a result, on a receiver side, whether the information is on the same vehicle or on different vehicle has to be determined and thereby increasing the determination process load.

Further, when vehicles are very crowded, in such a case that hundreds of vehicles are running in a swarm of traffic congestion, lack of communication channels may be worried about. In that case, if the communication device is configured to transmit the information on the surrounding vehicle positions, communication time of the communication channel for each of the transmissions of the information increases. As a result, possibility of the transmissions of the information at a non-appropriate timing may increase.

### SUMMARY OF THE DISCLOSURE

In view of the above and other problems, the present disclosure provides a technique that is designed to provide a right amount of communication data to be transmitted between communication apparatuses.

The communication apparatus for use in a subject vehicle includes a communication unit that communicates with another communication apparatus; a detection unit that detects an object around the subject vehicle; an object information input unit that inputs from the detection unit detected object information of the object that is detected by the detection unit; and a control unit that receives through the communication unit communication information from a first communication apparatus that is different from a subject communication apparatus and transmits through the communication unit the communication information to a second communication apparatus that is different from the subject communication apparatus. When the control unit performs a determination whether the communication information from the first communication apparatus includes information relevant to the object that is identified by the detected object information from the object information input unit, the control unit transmits the detected object information to the second communication apparatus upon having a negative result from the determination, and the control unit does not transmit the detected object information to the second communication apparatus upon having an affirmative result from the determination.

The communication apparatus does not transmits the information of the object that is identified by the detected object information from the object information input unit when information of the same object is already in the communication information from the first communication apparatus. That is, the object information in duplication is released to the network only by the first communication apparatus. Therefore, even when the second communication apparatus is capable of communicating with the first one and the communication apparatus on the subject vehicle, the information of the object is only received from the first communication apparatus. In this manner, the information of the same object will not be duplicated and duplication determination in the second communication apparatus is not needed. Further, a total data amount exchanged between the communication apparatuses is reduced.

### BRIEF DESCRIPTION OF THE DRAWINGS

Other objects, features and advantages of the present invention will become more apparent from the following detailed description made with reference to the accompanying drawings, in which:

FIGS. 1A and 1B show block diagrams of a driving support apparatus and a roadside apparatus in an embodiment of the present disclosure;

FIG. 2 shows a flowchart of a communication process in the embodiment;

FIG. 3 shows a flowchart of a sender vehicle information deletion process in the embodiment;

FIG. 4 shows a flowchart of a surrounding vehicle information deletion process 1 in the embodiment;

FIG. 5 shows a flowchart of a surrounding vehicle information deletion process 2 in the embodiment;

FIGS. 6A and 6B show diagrams of vehicle data list and vehicle types from a subject vehicle in the embodiment;

FIG. 7 shows a diagram of vehicle data list from another vehicle in the embodiment;

FIG. 8 shows a diagram of vehicle data list from a roadside apparatus in the embodiment;

FIG. 9 shows a diagram of vehicle type conversion in the embodiment;

FIG. 10 shows an illustration of position matching method in the embodiment;

FIG. 11 shows an illustration of vehicle information deletion method for deleting information on intermediate vehicles in the embodiment; and

FIG. 12 shows an illustration of another vehicle information deletion method for deleting information on intermediate vehicles in the embodiment.

### DETAILED DESCRIPTION

The embodiment which the present invention is applied to is explained with reference to the drawing in the following. In addition, the embodiment of the present invention may take various forms as long as it belongs to a technical scope pertinent to the present invention. Thus, the embodiments does not limit the technical scope of the invention.

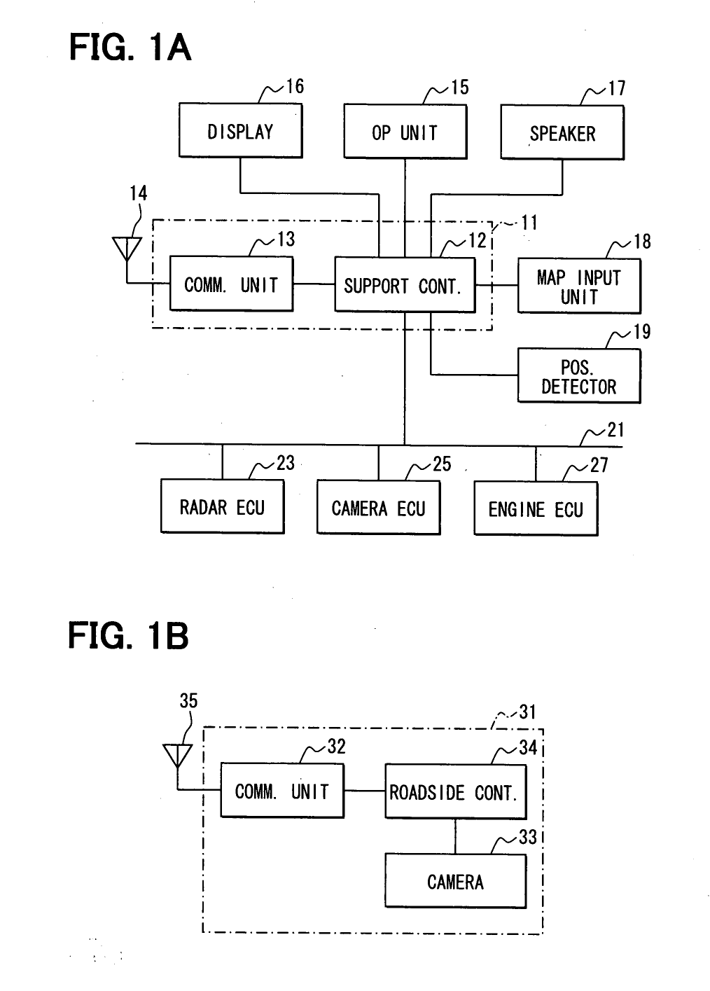

FIG. 1A is a block diagram to show a driving support apparatus 11 having a function of a communication apparatus of the present invention and a configuration of devices connected to the driving support apparatus 11. The driving support apparatus 11 is connected to an operation unit 15, a visual display unit 16, a voice-output unit 17, a map information input unit 18 and a position detector 19. In addition, the driving support apparatus 11 is connected to a vehicle local area network (vehicle LAN) 21, and the vehicle LAN 21 is connected to at least a radar ECU 23, a camera ECU 25 and an engine ECU 27 for communication with each other.

The driving support apparatus 11 includes a support control unit 12, a radio communication unit 13 and an antenna 14. The support control unit 12 consists of a well-known central processing unit (CPU), ROM, RAM, SRAM, I/F, and the like, and it integrally controls each part and each apparatus based on an internal program.

The radio communication unit 13 has a function for communicating with other driving support apparatus (the apparatus of the same kind as the driving support apparatus 11 of the present embodiment) and a roadside device 31 to be mentioned later. As a communication protocol, various types of protocols are used, and any protocol can be used as long as the protocol can transmit and receive communication data explained in the following substantially within an order of a tenth of a second.

The operation unit 15 consists of mechanical key switches, a touch panel being integrally formed with a display screen of the display unit 16, and switches formed as a wireless remote controller. The visual display unit 16 consists of a liquid crystal display or an organic electroluminescence (EL) display or the like, and it is the device which can display a color image.

The voice-output unit 17 consists of a speaker, an amplifier and the like, and it is the device which can output a voice signal as a sound. The map information input unit 18 is a device to input various data on a map data memory medium (for example, a hard disk, a DVD-ROM or the like) which is not illustrated. On a map data memory medium, map data (node data, link data, cost data, background data, road data, name data, mark data, crossing data, facility data and the like), audio data for guidance, sound recognition data are memorized. In addition, instead of inputting these data from the map data memory medium, these data may be input through a communication network.

The position detector 19 detects a position of the vehicle which the driving support apparatus 11 is disposed on and a direction based on a signal provided from a GPSantenna, a gyroscope which are not illustrated, and the detector 19 outputs positional information and direction information to the support control unit 12.

The radar ECU 23 is an ECU that processes a signal provided from the radar antenna which is not illustrated, and calculates a position, a movement direction and a travel speed and the like of the object. In addition, the ECU 23 works with either of a passive type radar or an active type radar. For the wavelength that the radar antenna detects, a millimeter wave of 30 GHz to 300 GHz is appropriate.

The camera ECU 25 is an ECU that processes a signal provided from the charge-coupled device (CCD) camera which is not illustrated, and calculates a position, a movement direction, a travel speed and the like of the object. In addition, for the CCD camera, an infrared CCD camera that can easily capture images in darkness is preferable.

The engine ECU 27 is an ECU that controls an ignition timing of a spark plug, a valve opening and shutting timing, a fuel injection timing and the like. In addition, a signal from a throttle sensor disposed on a throttle as well as a signal from a speed sensor disposed in a hub of a wheel and a shift position signal from AT-ECU are acquired and utilized for controlling those timings (none of those sensors are illustrated).

FIG. 1B is a block diagram showing a configuration of the roadside device 31 that the driving support apparatus 11 communicates with. The roadside device 31 includes the radio communication unit 32, a camera unit 33 and a roadside control unit 34.

The radio communications unit 32 has a function that communicates with the driving support apparatus 11 through the antenna 35. As a communication protocol, various types of protocols are used, and any protocol can be used as long as the protocol can transmit and receive communication data explained in the following substantially within an order of a tenth of a second.

The camera unit 33 processes a signal provided from the CCD camera, and calculates a position and/or a distance to the object. In addition, for the CCD camera, the infrared CCD camera that can easily capture images in darkness is preferable.

The roadside control unit 34 consists of a well-known central processing unit (CPU), ROM, RAM, SRAM, I/F, and the like, and performs processes based on an internal program. More practically, the control unit 34 performs a function to transmit information about a distance and/or a position of an object detected by the camera unit 33 to the driving support apparatus 11 which requested a transmission of the information.

The process performed in the support control unit 12 of the driving support apparatus 11 is explained next. In this case, only the processing that characterizes the present invention is explained, and explanation for other part is omitted. In addition, a processing to display driving support information on the visual display unit 16 may be performed according to a method disclosed in the JP-A-2004-115587 or to a method of other well-known guidance display process.

(1) Communication Process

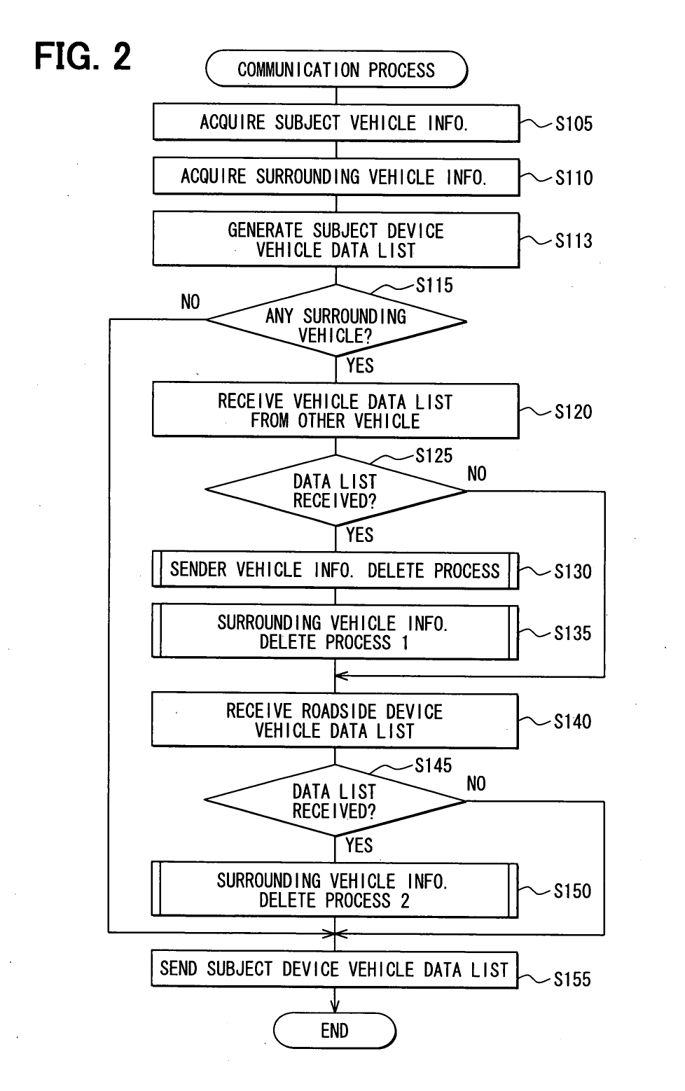

First, a communication process is explained with reference to a flowchart in FIG. 2. When an instruction for starting the communication process is input from the operation unit 15 as an operation by a driver on a vehicle that is equipped with the driving support apparatus 11 (the vehicle is designated as a subject vehicle hereinafter), or when the subject vehicle enters into a predetermined area such as an intersection or the like, or when a request for data transmission from another vehicle is received, the communication process is started.

When the support control unit 12 starts execution of the communication process, the control unit 12 first acquires subject vehicle information (S105). The acquisition of the subject vehicle information means acquiring direction information from the position detector 19, and acquiring speed information from the engine ECU 27.

Then, information of surrounding vehicles is acquired next (S110). Acquisition of the surrounding vehicle information means acquiring positions, travel directions and/or speed of the surrounding vehicles from the radar ECU 23 and the camera ECU 25. In addition, the word “surrounding” means, for example, an area that extends about 400 meters in front of the subject vehicle, about 100 meters in rear of the subject vehicle, and about 30 meters on both sides of the subject vehicle.

Then, the subject vehicle information acquired in S105 and the surrounding vehicle information acquired in S110 are used to generate subject device vehicle data list (S113).

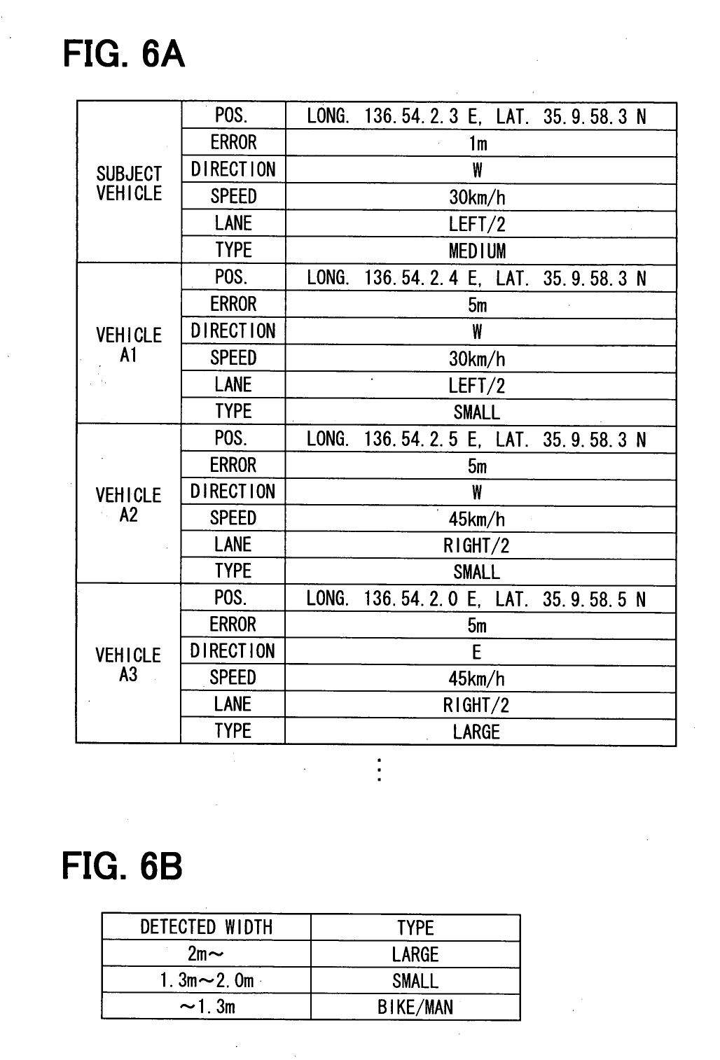

An example of the subject device vehicle data list is described with reference to a diagram in FIG. 6A. The subject device vehicle data list in FIG. 6A is a list of data of the subject vehicle and data of the surrounding vehicles, and data of each vehicle consists of a vehicle position, an error, a travel direction, the vehicle speed, a traffic lane, and a vehicle type. Each of the items of the data are described as follows. That is, “vehicle position” is, as literally represented, a position of the vehicle (i.e., a center of the vehicle in a more precise manner) defined by the longitude and the latitude. “Error” is an error of data showing the vehicle position. In this case, as for the error, the error represents an error of the position information of the subject vehicle in addition to detection errors of the radar ECU 23 and the camera ECU 25. Further, the travel direction represents a traveling direction of the vehicle in one of sixteen predetermined directions such as south-southeast or the like. Further, “vehicle speed” is, as literally represented, the speed of the vehicle designated in a speed per hour. “Traffic lane” is information regarding which traffic lane the vehicle is traveling on when there are plural traffic lanes in a road. “Vehicle type” is a type of vehicle that is determined based on vehicle width information from the radar ECU 23 and the camera ECU 25 and based on a type conversion list. In this case, the subject vehicle uses a predetermined type of vehicle.

An example of the vehicle conversion list is explained with an illustration in FIG. 6B. The type conversion list in FIG. 6B consists of detected vehicle width (up to 1.3 m, 1.3 m-2.0 m, 2 m or more) and a type of vehicle corresponding to the detected width (a two-wheel vehicle/a person, a small-size automobile, a large automobile). In this case, “a person” is not a vehicle in the strict sense of the word, but it is treated as a vehicle for convenience' sake in the description of the present embodiment.

Then, based on the subject device vehicle data list generated in S113, whether there is the surrounding vehicle is determined (S115). That is, whether there is data about the surrounding vehicles in a list of subject device vehicle data. When it is determined that there is a surrounding vehicle (S115:Yes), the process proceeds to S120. When the surrounding vehicle is not detected (S115:No), the process proceed to S155.

### In S120, the reception of a list of other device vehicle data from the other vehicle (i.e., the vehicle that is equipped with the apparatus of the same type as the driving support apparatus 11) is attempted.

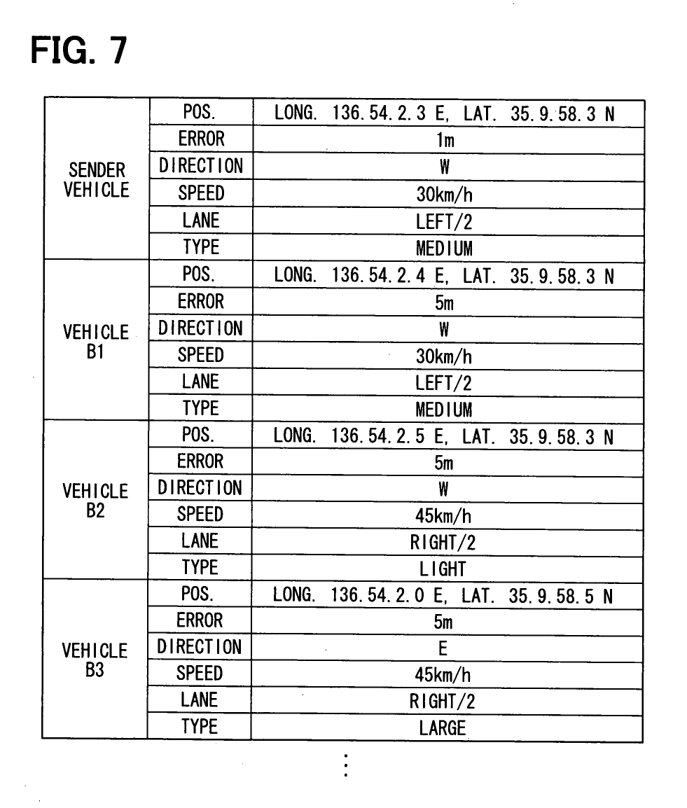

An example of a list of other device vehicle data is explained with reference to a diagram in FIG. 7. The other device vehicle data list shown in FIG. 7 is a list of data about a sender vehicle and the surrounding vehicles of the sender vehicle. The data of each of the vehicles includes data of the vehicle position, the error, the travel direction, the traffic lane, and the vehicle type. In this cases the data of each vehicle are similar to the list of subject device vehicle data mentioned above.

In S125, whether the other device vehicle data list has been received in S120 is determined. When the data list is received (S125:Yes), the process proceeds to S130. When the data list is not received (S125:No), the process proceeds to S140.

In S130, a sender vehicle information deletion process is performed. Details of the sender vehicle information deletion process is described later.

Then, a surrounding vehicle information deletion process 1 is performed (S135). Details of this deletion process 1 is also described later.

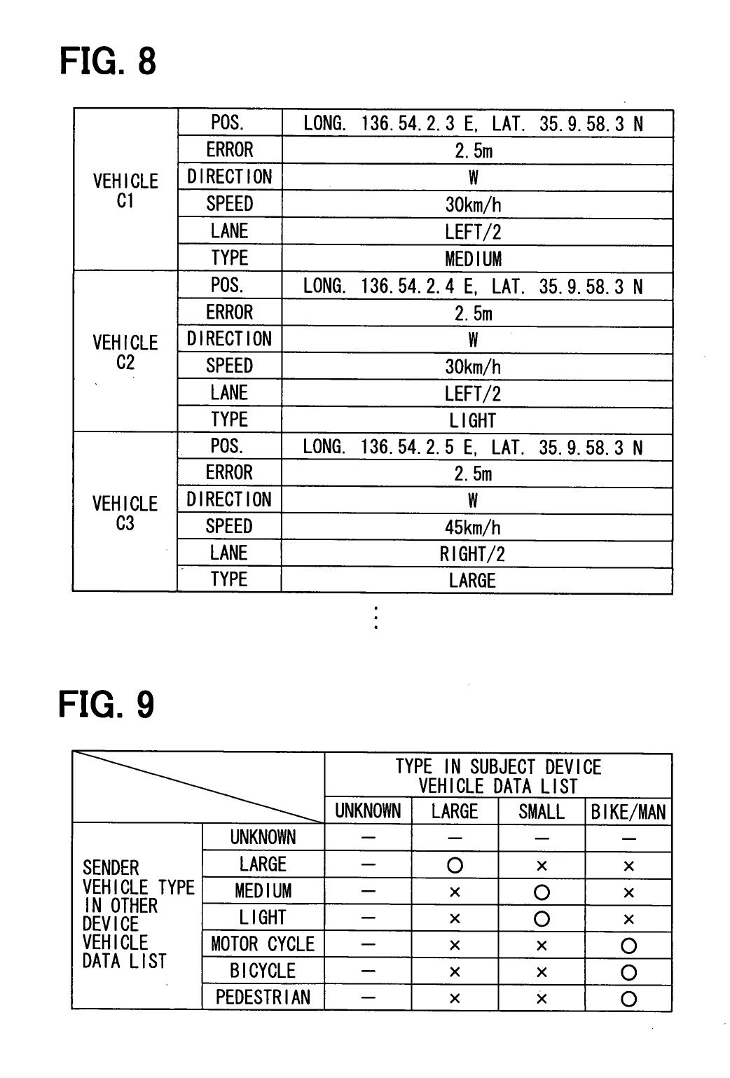

Then, in S140, the reception of a list of roadside device vehicle data from the roadside device 31 is attempted. An example of a list of roadside device vehicle data to be received from the roadside device 31 is shown in FIG. 8. The list of roadside device vehicle data in FIG. 8 is a list of data about the surrounding vehicles around the roadside device 31, and data of each vehicle includes the vehicle position, the error, the travel direction, the vehicle speed, the traffic lane, and the vehicle type. The data of each vehicle are similar in the list of the subject device vehicle data stated above.

Then, in S145, whether the list of roadside device vehicle data has been received from the roadside device 31 is determined. When the list of roadside device vehicle data has been received (S145:Yes), the process proceeds to S150. When the list has not been received (S145:No), the process proceeds to S155.

In S150, a surrounding vehicle information deletion process 2 is performed. Details of this surrounding vehicle information deletion process 2 is described later.

Then in S155, the list of subject device vehicle data is transmitted to the other vehicle through the radio communication unit 13, and the communication process is finished.

(2) Sender Vehicle Information Deletion Process

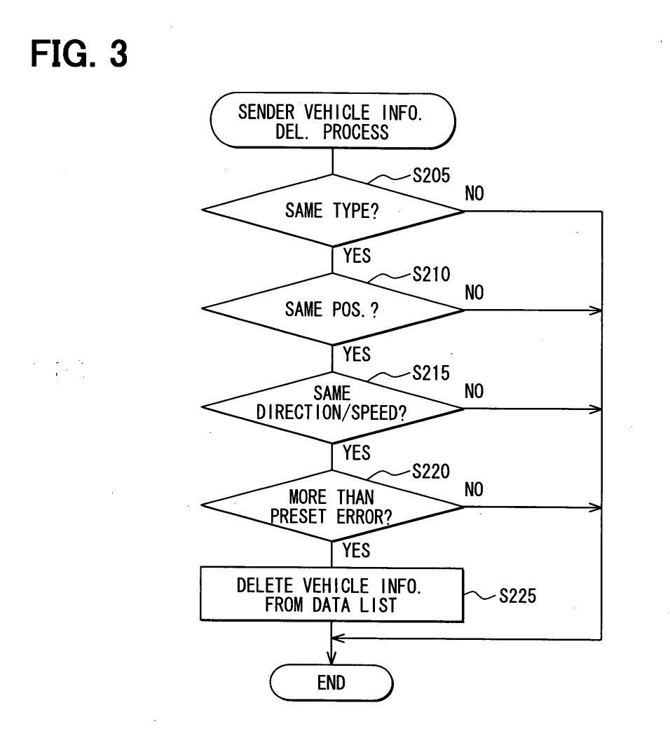

The sender vehicle information deletion process by the support control unit 12 in the driving support apparatus 11 is described with reference to a flowchart in FIG. 3. The sender vehicle information deletion process is called and started in S130 of the above-described communication process.

First, the support control unit 12 determines whether “information on the sender vehicle of the other device vehicle data list” received in S120 of the communication process is existing in the “subject device vehicle data list” generated in S113 of the communication process. Each of the determination steps is explained sequentially as follows.

In S205, the control unit 12 determines whether there is vehicle information of the same vehicle type as the sender vehicle in the subject device vehicle data list. In this case, because the vehicle type is determined based on the vehicle width information derived from the radar ECU 23 and from the camera ECU 25, the accuracy might not be very high in some cases. Thus, the vehicle type may be determined based on the vehicle type of the sender vehicle in the other device vehicle data list when the classification of the vehicle types are more accurate and detailed in the other device vehicle data list.

The vehicle type conversion list (i.e., a diagram) is explained with reference to FIG. 9. In the vehicle type conversion list in FIG. 9, the vehicles are categorized as “Unknown”, “Large (automobile)”, “Medium (automobile)”, “Light (automobile)”, “Motorcycle”, “Bicycle”, “Pedestrian” in the classification of the sender vehicle type in the other device vehicle list, and also categorized as “Unknown”, “Large (automobile)”, “Small (automobile)”, “Bike/person” in the classification of the subject device vehicle data list. The combinations of these classifications are defined either as an agreement or disagreement (“◯”, “X”) and not-determined (“−”). In this case, the not-determined case may be handled as an agreement (“◯”).

When the information of the same vehicle type is determined to be existing in the subject device vehicle data list (S205:Yes), the process proceeds to S210. When the information of the same vehicle type is not determined to be existing in the subject device vehicle data list (S205:No), the process (sender vehicle information deletion) concludes itself to return to S130 of the communication process.

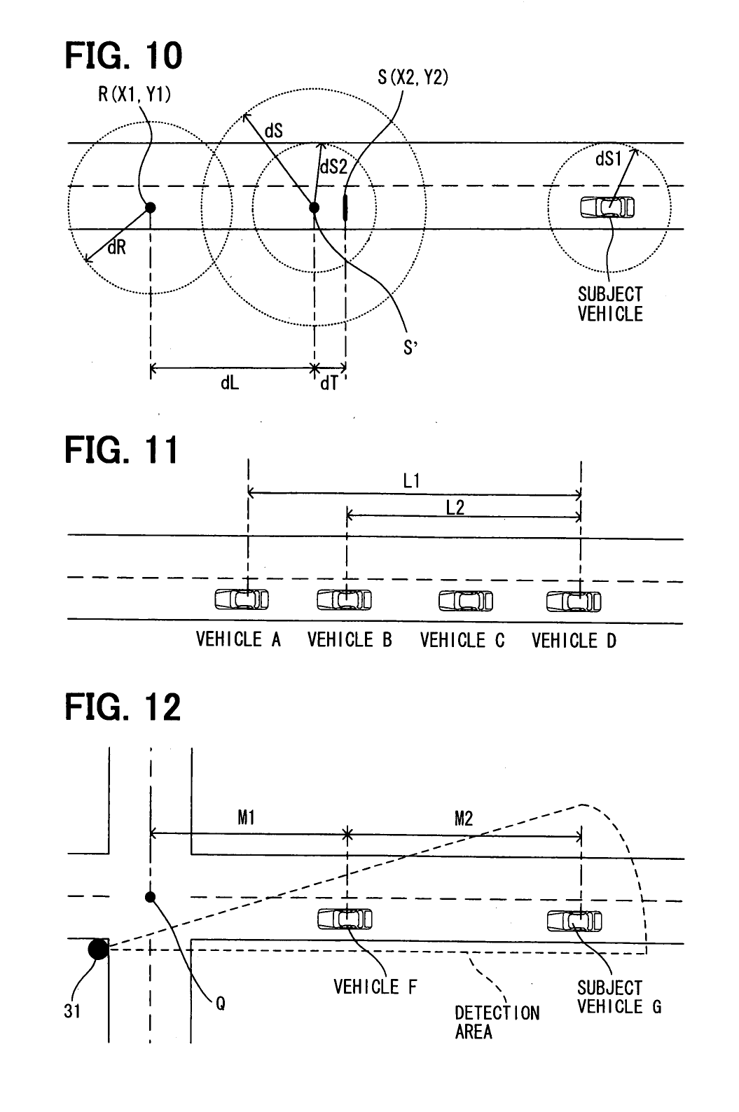

In S210, the process determines whether information on the same type vehicle that is at the same position as the sender vehicle and is existing in the subject device vehicle data list. How this determination (i.e., position matching) takes place is explained with reference to an illustration in FIG. 10.

First, vehicle position coordinates of the surrounding vehicles set in the subject device vehicle data list is explained. The center position S′ of the vehicle is used as this position coordinates. The position S′ is calculated based on a vehicle's rear end position coordinates S derived from the radar ECU 23 and the camera ECU 25. More practically, the vehicle's center position S′ is calculated by modifying the position S by a half of the total length of the vehicle dT. The length dT is, for example, calculated based on the detected vehicle width. That is, the length dT is calculated as 3 meters when the vehicle is a large automobile, calculated as 2 meters when the vehicle is a medium automobile, or calculated as 1 meter when the vehicle is a motorcycle.

In the determination process, a distance dL between position coordinates R of the sender vehicle and the center position S′ of the same vehicle is calculated first. Further, the error dS of the center position S′ is calculated. More practically, the error dS is calculated by adding the error dS1 of the subject vehicle to the detection error dS2 of the radar ECU 23 and the camera ECU 25.

dS=dS1+dS2 (Equation 1)

In this case, information equivalent to the error dS is used as the error in the subject device vehicle data list.

Then, the error dR of the sender vehicle's position R (i.e., the “Error” in the other device vehicle data list) is used for the determination. More practically, when the distance dL is equal to or smaller than the sum of the dS and dR, these two vehicles are determined to be identical (i.e., determined to be the same vehicle). On the other hand, when the distance dL is greater than the sum of the dS and dR, these vehicles are determined to be different (i.e., determined to be different vehicles).

In this manner, each of the vehicles in the subject device vehicle data list is sequentially examined for determining whether the vehicle information that specifies the same position as the sender vehicle's position is existing in the data list.

When information of the vehicle which accords with a position of the sender vehicle is determined to be in the subject device vehicle data list (S210:Yes), the process proceeds to S215. When there is no information of the vehicle which accords with a position of the sender vehicle in the subject device vehicle data list (S210:No), the process (sender vehicle information deletion) concludes itself to return to the calling sequence S130 of the communication process.

In S215, the process determines whether there is, among the vehicles in the data list identified in S210, a vehicle that has the same travel direction and same speed as the sender vehicle. This determination of agreement does not have to be very precise, or in other words, the agreement is roughly sought for identifying the vehicle. For example, as for the travel direction, whether a vehicle advances to which direction on a road is identified. As for the speed, for example, by categorizing speed levels as “L=0-10 km/h, M=10-30 km/h, H=30-60 km/h, and SH=60 km/h”, the agreement is sought either as the same level or as the adjacent level.

When, in S215, there is the vehicle which accords with each other (S215:Yes), the process proceeds to S220. When there is no vehicle which accords with each other (S215:No), the process concludes itself to return to the calling sequence S130 of the communication process.

In S220, the process determines whether the error of the vehicle identified in the subject device vehicle data list in S215 is equal to or greater than a predetermined value. In this case, the predetermined value indicates that a value derived by multiplying the error dR of the sender vehicle by a predetermined index value such as 0.3 or the like. When it is determined that the error is equal to or greater than the predetermined value (S220:Yes), the process proceeds to S225. When the error is determined to be smaller than the predetermined value (S220:No), the process concludes itself to return to the calling sequence S130 of the communication process.

In S225, the vehicle data of the affirmative determination (Yes) in S205 to S215 is deleted from the subject device vehicle data list. That is, the vehicle information of the sender vehicle is deleted from the data list. Then, the process (sender vehicle information deletion) concludes itself to return to the calling sequence S130 of the communication process.

(3) Surrounding Vehicle Information Deletion Process 1

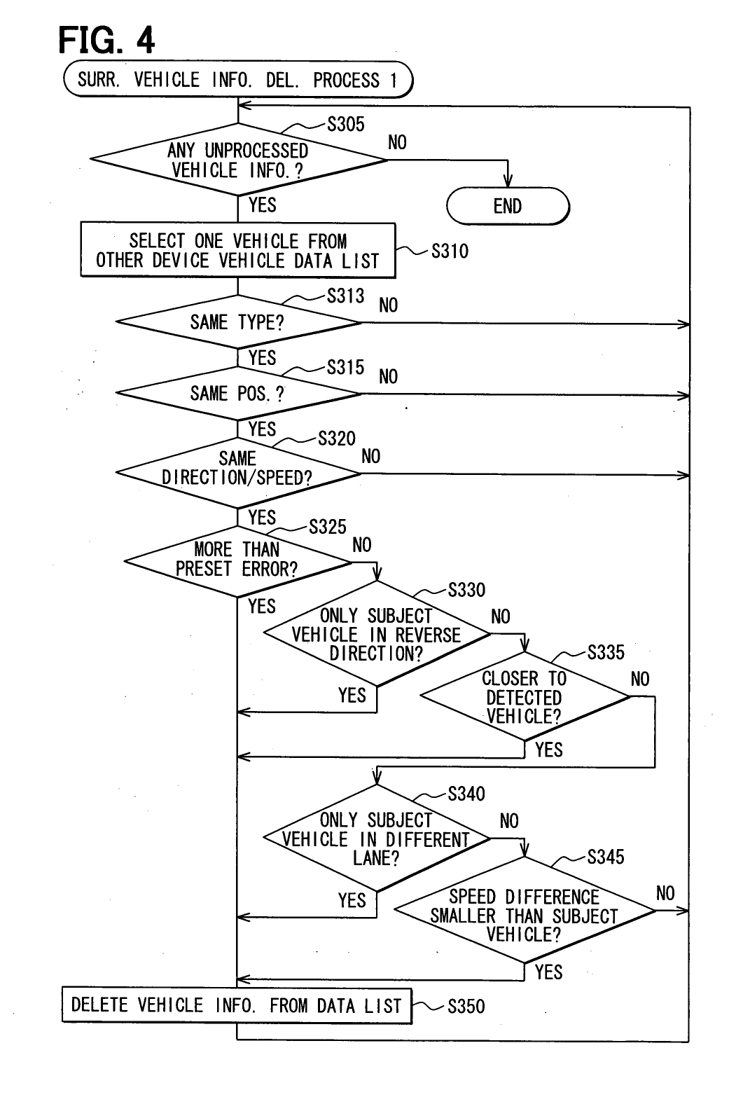

The surrounding vehicle information deletion process 1 carried out by the support control unit 12 of the driving support apparatus 11 is explained with reference to a flowchart in FIG. 4 next. The surrounding vehicle information deletion process 1 is called for execution in S135 of the communication process stated above.

The support control unit 12 determines whether at first there is vehicle information yet to be processed is determined in the surrounding vehicle information deletion process 1 (S305). “Vehicle information yet to be processed” in this case means the vehicle information included in the other device vehicle data list acquired in S120 stated above, and the vehicle information of the vehicle which is not yet chosen in S310 to be mentioned later.

When it is determined that there is the vehicle information yet to be processed (S305:Yes), the process proceeds to S310. When it is determined that there is no vehicle information yet to be processed (S305:No), the process concludes itself to return to the calling sequence S135 of the communication process for resuming.

In S310, one of the vehicles is chosen from the vehicle information yet to be processed (the vehicle chosen may also be designated as a “choice vehicle” hereinafter). Then, the process determines whether there is the vehicle information of the same vehicle type as the choice vehicle in the subject device vehicle data list (S313). In this case, the vehicle type is identical to the one defined in the description of S205. When it is determined that the same vehicle type information exists (S313:Yes), the process proceeds to S315. In this case, the vehicle (one vehicle or more) determined to be agreeing with each of the conditions in S313 and in S315 to S320 in the following at the time of determination in each step after chosen from the subject device vehicle data list may also be designated as a “focus vehicle.”

In S315, it is determined whether there is information of the focus vehicle(s) agreeing with the positional information of the choice vehicle is determined. This determination is similar to the one in S210. When it is determined that there is the information of the focus vehicle(s) that its position accords with the choice vehicle (S315:Yes), the process proceeds to S320. When it is determined that there is no information of the focus vehicle(s) that its position accords with the choice vehicle (S315:No), the process returns to S305.

In S320, it is determined whether there is information of the focus vehicle(s) agreeing with the travel direction and the speed of the choice vehicle is determined. In this case, the direction and the speed are determined by the similar method as the one described in S215. When it is determined that there is the information of the focus vehicle(s) that the position and the speed accords with the choice vehicle (S320:Yes), the process proceeds to S325. When it is determined that there is no information of the focus vehicle(s) that the position and the speed accords with the choice vehicle (S320:No), the process returns to S305.

In S325, it is determined whether an error of the agreeing focus vehicle is equal to or greater than the predetermined value. The “error” in this case is similar to the “error” explained in S220 (however, the sender vehicle is replaced with the choice vehicle). When it is determined that the error is equal to or greater than the predetermined value (S325:Yes), the process proceeds to S350. When it is determined that the error is not greater than the predetermined value (S325:No), the process returns to S305.

In S330 which comes after it is determined that the error is equal to or greater than the predetermined value, the travel direction of the subject is compared with the travel direction of the sender vehicle in the other device vehicle data list and with the focus vehicle for determining whether only the subject vehicle (i.e., the focus vehicle) is traveling in a reverse direction. The determination of the travel direction is performed in the same manner as the determination described in S215. When only the subject vehicle is traveling in the reverse direction (S330:Yes), the process proceeds to S350. When the subject vehicle is not the only vehicle traveling in the reverse direction (S330:No), the process proceeds to S335.

In S335 which comes after it is determined that the subject vehicle is not the only vehicle that travels in the reverse direction, the degree of closeness of the sender vehicle to the focus vehicle relative to the subject vehicle is determined. When it is determined that the sender vehicle is closer to the focus vehicle relative to the subject vehicle by a predetermined degree (e.g., the degree of closeness is 1.2) or more (S335:Yes), the process proceeds to S350. When it is determined that the sender vehicle is not closer to the focus vehicle relative to the subject vehicle by the predetermined degree (S335:No), the process proceeds to S340.

In S340 to be advanced when it is determined that the subject vehicle is closer to the focus vehicle than the sender vehicle, the traveling lane of the sender vehicle and the traveling lane of the focus vehicle are compared with the traveling lane of the subject vehicle, whether only the traveling lane of the subject vehicle is different is determined. When only the traveling lane of the subject vehicle is different (S340:Yes), the process proceeds to S350. When the subject vehicle is not traveling in different lane (S340:No), the process returns to S305.

In S345 which comes after only the subject vehicle is traveling in the different lane, it is determined whether speed difference between the sender vehicle and the focus vehicle is smaller than speed difference between the subject vehicle and the focus vehicle. The determination of the speed is performed by a method same as the one explained in S215. When the speed difference of the sender vehicle relative to the focus vehicle is determined to be smaller (S345:Yes), the process proceeds to S350. When the speed difference of the sender vehicle relative to the focus vehicle is not determined to be smaller (S345:No), the process returns to S305.

In S350, information about the focus vehicle is deleted from the list of subject device vehicle data. Then, the process returns to S305.

(4) Surrounding Vehicle Information Deletion Process 2

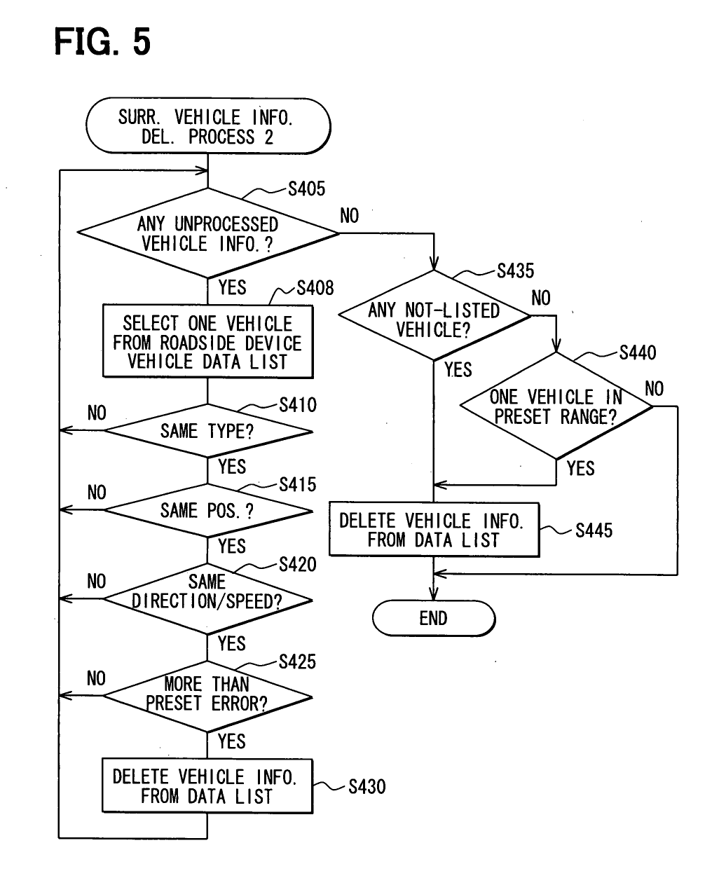

The surrounding vehicle information deletion process 2 by the support control unit 12 of the driving support apparatus 11 is explained with reference to a flowchart in FIG. 5 next. In this case, the surrounding vehicle information deletion process 2 is called for execution in S150 of the communication process stated above.

The support control unit 12 determines whether at first there is the vehicle information yet to be processed when the surrounding vehicle information deletion process 2 is started (S405). “Vehicle information yet to be processed” in this case means the vehicle information included in the roadside device vehicle data list acquired in S140 of the communication process stated above, and the vehicle information of the vehicle which is not yet chosen in S408 to be mentioned later.

When it is determined that there is the vehicle information yet to be processed (S405:Yes), the process proceeds to S408. When it is determined that there is no vehicle information yet to be processed (S405:No), the process proceeds to S435.

In S408 which comes after it is determined that there is the vehicle information yet to be processed, one of the vehicles is chosen from the vehicle information yet to be processed (the vehicle chosen may also be designated as a “choice vehicle” hereinafter). Then, the process determines whether there is the vehicle information of the same vehicle type as the choice vehicle in the subject device vehicle data list (S410). In this case, the vehicle type is identical to the one defined in the description of S205. When it is determined that the same vehicle type information exists (S410:Yes), the process proceeds to S415. In this case, the vehicle (one vehicle or more) determined to be agreeing with each of the conditions in S410 and in S415 to S425 in the following at the time of determination in each step after chosen from the subject device vehicle data list may also be designated as a “focus vehicle.”

In S415 which comes after it is determined that the same type vehicle exists, it is determined whether there is information of the focus vehicle(s) agreeing with the positional information of the choice vehicle is determined. This determination is similar to the one in S210. When it is determined that there is the information of the focus vehicle(s) that its position accords with the choice vehicle (S415:Yes), the process proceeds to S420. When it is determined that there is no information of the focus vehicle(s) that its position accords with the choice vehicle (S415:No), the process returns to S405.

In S420 which comes after it is determined that there is a vehicle among the focus vehicle(s) at the same position as the choice vehicle, it is determined whether there is information of the focus vehicle(s) agreeing with the travel direction and the speed of the choice vehicle is determined. In this case, the direction and the speed are determined by the similar method as the one described in S215. When it is determined that there is the information of the focus vehicle(s) that the position and the speed accords with the choice vehicle (S420:Yes), the process proceeds to S425. When it is determined that there is no information of the focus vehicle(s) that the position and the speed accords with the choice vehicle (S420:No), the process returns to S405.

In S425 which comes after it is determined that there is the information of the focus vehicle(s) that the travel direction and the speed are identical with the choice vehicle, it is determined whether an error of the agreeing focus vehicle(s) is equal to or greater than the predetermined value. The “error” in this case is similar to the “error” explained in S220 (however, the sender vehicle is replaced with the choice vehicle). When it is determined that the error is equal to or greater than the predetermined value (S425:Yes), the process proceeds to S430. When it is determined that the error is not greater than the predetermined value (S425:No), the process returns to S405.

In S430 which comes after it is determined that the error of the focus vehicle(s) is equal to or greater than the predetermined value, information about the focus vehicle(s) is deleted from the list of subject device vehicle data. Then, the process returns to S405.

In S435 which comes after it is determined that the vehicle information yet to be processed, the process determines whether the vehicle that is not in the roadside device vehicle data list exists in the subject device vehicle data list. When it is determined that there is such a vehicle (S435:Yes), the process proceeds to S445. When it is determined that there is no such vehicle (S435:No), the process proceeds to S440.

In S440, it is determined whether there is only one agreeing vehicle in each of the roadside device vehicle data list and the subject device vehicle data list in terms of existence in a predetermined area (with an exception of the subject vehicle in the subject device vehicle data list). In this case, “the predetermined area” is, for example, a specific portion of a detection coverage area of the roadside device 31. The predetermined area may also be an area assigned to each of the vehicle in the list with a radius of 50 meters for determining the condition vehicle by vehicle. When, in S440, the condition is affirmed (S440:Yes), the process proceeds to S445 with the agreeing vehicle in the subject device vehicle data list set as the focus vehicle. When the condition is determined as negative (S440:No), the process concludes itself.

In S445, information about a vehicle in the subject device vehicle data list which became an object of determination in S435 and S440 is deleted. Then, the process concludes itself.

According to the driving support apparatus 11 stated above, information about the vehicle which co-exists in the other device vehicle data list is deleted from the subject device vehicle data list (S350). Further, the information of the vehicle which co-exists in the roadside device vehicle data list is also deleted from the subject device vehicle data list (S430). Furthermore, the sender vehicle information in the subject device vehicle data list is also deleted (S225).

Therefore, vehicle information is not transmitted in a duplicating manner, thereby enabling a reduction of the data amount exchanged between the driving support apparatuses.

However, when the vehicle information in the subject device vehicle data list has a greater accuracy by a predetermined degree than the vehicle information in the other device vehicle data list or the roadside device vehicle data list, the vehicle information will not be deleted from the subject device vehicle data list (S325:No, S425:No).

Therefore, information having greater accuracy is transmitted to other driving support apparatuses, thereby enabling a provision of greatly accurate information for the driver from other driving support apparatuses.

Although the present invention has been fully described in connection with the preferred embodiment thereof with reference to the accompanying drawings, it is to be noted that various changes and modifications will become apparent to those skilled in the art.

For example,

(1) The following process may be added before transmitting a list of subject device vehicle data in S155. That is, the process first determines whether there is in a list of subject device vehicle data a group of vehicles running in the same traffic lane. When the group of the vehicles is found, a distance between the top vehicle and a tail vehicle is calculated, and whether the distance is equal to or less than a predetermined value is determined. When the distance is smaller than the predetermined value, information of the vehicle(s) between the top vehicle and the tail vehicle is deleted from the subject device vehicle data list. When the distance is not smaller than the predetermined value, the vehicles used in the determination are replaced with other vehicles, and the vehicle(s) interposed between within-predetermined-distance vehicles is/are deleted. In this case, the predetermined distance may be varied according to the speed of the vehicle. For example, the predetermined distance may be calculated as a product of a speed (m/s) and an index (e.g., 2) added to a standard distance (e.g., 15 meters).

A concrete example of the predetermined distance is shown in FIG. 11. In a list of subject device vehicle data, it is assumed that there is information about vehicles A to D. In this case, the distance between the vehicle A and vehicle D is calculated as a distance L, and it is determined whether the calculated distance L1 is equal to or smaller than a predetermined distance. When the distance L1 is equal to or smaller than the predetermined distance, information about the vehicle B and information about the vehicle C are deleted from the list of subject device vehicle data. Further, when the distance L1 is not equal to or smaller than the predetermined distance, a distance L2 between the vehicle B and the vehicle D or between the vehicle A and the vehicle C is calculated. When the distance L2 is equal to or smaller than the predetermined distance, information about the vehicle C may be deleted from the list of subject device vehicle data.

In this manner, by deleting redundant vehicle information, the total data amount exchanged between the driving support apparatuses may be further reduced.

(2) The following is an example of the process in S425 with reference to FIG. 12 for a case when information about the error is not set in the roadside device vehicle data list which is transmitted from the roadside device 31.

When the error information is not set in the data list, a distance M1 between a measurement reference point Q of the roadside device 31 may be preferably compared with a distance M2 between a position of a subject vehicle G and a focus vehicle F. In this case, the measurement reference point Q is a point to be used as a reference point in the measurement data when the roadside device 31 transmits the measurement data.

More practically, when the distance M1 is smaller than twice of the distance M2, the focus vehicle F may be determined as the vehicle for deletion (S425:Yes). The reason why the data from the roadside device 31 is prioritized is that the roadside device 31 can be equipped with highly accurate sensors relative to the driving support apparatus 11 disposed on the vehicle. That is, the information transmitted from the roadside device 31 is considered to be more accurate.

In this manner, the vehicle information can appropriately be handled when the error information is not set in the roadside device vehicle data list.

(3) The subject device vehicle data list may be corrected by using the data in the roadside device vehicle data list in the above embodiment, instead of deleting the information of the vehicle which is co-existing in the roadside device vehicle data list and in the subject device vehicle data list from the subject device vehicle data list. This is because of the higher accuracy of the sensors disposed in the roadside apparatus 31, which leads to the higher accuracy of the information transmitted from the apparatus 31.

In this manner, the accuracy of the data which the driving support apparatus 11 transmits is improved.

(4) The data of the vehicle not existing in the subject device vehicle data list but included in the roadside device vehicle data list may be transmitted to the other driving support apparatuses. That is, in other words, such a vehicle data may preferably be appended to the subject device vehicle data list at the end of the surrounding vehicle information deletion process 2.

In this manner, the driving support apparatuses of other vehicles can utilize the information of the vehicle which is detected by the roadside device 31 even when the other vehicles are in a non-communicable condition with the roadside device 31, due to the transmission of the information of the vehicle that has not been detected by the radar ECU 23 and the camera ECU 25 to the driving support apparatuses on the other vehicles.

Such changes and modifications are to be understood as being within the scope of the present invention as defined by the appended claims.

Correspondence of the terms used in the description of the above embodiment to more conceptual language is shown in the following. That is, the radio communication unit 13 may be equivalent to a communication unit, the radar ECU 23 and the camera ECU 25 may be equivalent to a detection unit, S110 in the communication process may be equivalent to an object information input unit, and the support control unit 12 may be equivalent to a control unit.

What is claimed is:

1. A communication apparatus for use in a subject vehicle comprising:
a communication unit that communicates with another communication apparatus;
a detection unit that detects an object around the subject vehicle;
an object information input unit that inputs from the detection unit detected object information of the object that is detected by the detection unit; and
a control unit that receives through the communication unit communication information from a first communication apparatus that is different from a subject communication apparatus and transmits through the communication unit the communication information to a second communication apparatus that is different from the subject communication apparatus, wherein, when the control unit performs a determination whether the communication information from the first communication apparatus includes information relevant to the object that is identified by the detected object information from the object information input unit, the control unit transmits the detected object information to the second communication apparatus upon having a negative result from the determination, and the control unit does not transmit the detected object information to the second communication apparatus upon having an affirmative result from the determination.

2. The communication apparatus of claim 1, wherein
the control unit includes the detected object information in the communication information to be transmitted to the second communication apparatus through the communication unit even when the information relevant to the object that is identified by the detected object information from the object information input unit is determined to be included in the communication information from the first communication apparatus provided that accuracy of the detected object information from the object information input unit is greater by a predetermined degree than accuracy of the information in the communication information from the first communication apparatus.

3. The communication apparatus of claim 1, wherein
the control unit relays the detected object information in the communication information from the first communication apparatus to the second communication apparatus when the detected object information identifies an object that has not been detected by the detection unit.

4. The communication apparatus of claim 1, wherein
the object in the determination is a vehicle that is equipped with the first communication apparatus.

5. The communication apparatus of claim 1, wherein
the first communication apparatus is a roadside apparatus disposed on a roadside.

6. The communication apparatus of claim 1, wherein
the control unit takes account of a comparison result that is derived from a comparison for comparing position information of the object in the detected object information and position information of the object in the communication information for performing the determination.

7. The communication apparatus of claim 6, wherein
the control unit takes account of, for performing the comparison, an error of a position of the subject vehicle, an error inherent in the detection unit, and an error of the position information that is included in the communication information together with the position information.

8. The communication apparatus of claim 1, wherein
the control unit performs the determination by taking account of a comparison result derived from a comparison for comparing travel direction information of the object in the detected object information and travel direction information of the object in the communication information.

9. The communication apparatus of claim 1, wherein
the control unit performs the determination by taking account of a comparison result derived from a comparison for comparing travel speed information of the object in the detected object information and travel speed information of the object in the communication information.

10. The communication apparatus of claim 1, wherein
the control unit transmits the detected object information for representing a group of vehicles traveling in a same direction to the second communication apparatus,
the control unit deletes the detected object information about at least one vehicle in the group of vehicles when the group of vehicles includes at least one vehicle between a front end vehicle in the group of vehicles and a rear end vehicle in the group of vehicles, and
the control unit performs a deletion of information about at least one intermediate vehicle in a group of vehicles before transmitting the detected object information to the second communication apparatus provided that both of a first condition whether the detected object information includes information about the group of vehicles traveling in a same direction and a second condition whether a distance between a front end vehicle and a rear end vehicle in the group of vehicles is within a predetermined value are affirmatively determined.

11. A program product stored in a storage medium for controlling a computer comprising:
controlling the computer to be serving as the control unit of claim 1.
